(19) United States
(12) Patent Application Publication
(10) Pub. No.: US 2026/0208305 A1
(43) Pub. Date: Jul. 23, 2026

(54) SHIMS HAVING GUIDED FRACTURE LINES

(71) Applicant: The Boeing Company, Arlington, VA (US)

(72) Inventor: Aaron Park, Austin, TX (US)

(21) Appl. No.: 19/035,281

(22) Filed: Jan. 23, 2025

(51) Int. Cl. B23P 19/10

(52) U.S. Cl. CPC B23P 19/10

(57) ABSTRACT

Shims having guided fracture lines are disclosed. An example apparatus includes a shim to be positioned between a first component and a second component, the first component to be fastened to the second component, and a guided fracture line positioned in the shim, the guided fracture line defining a joint portion of the shim and a removable portion of the shim, the removable portion of the shim to extend outside of a peripheral edge of one of the first component or the second component, the guided fracture line to enable removal of the removable portion after the first component is fastened to the second component.

### FIELD OF THE DISCLOSURE

This disclosure relates generally to shims and, more particularly, to shims having guided fracture lines.

### BACKGROUND

Components of an assembly are often required to be joined together with an accuracy within a preselected tolerance. For instance, in the aerospace industry, some components may be required to be assembled together with less than a threshold gap (e.g., 0.1 inches, 0.005 inches, etc.) between the components. When the gap exceeds the preselected tolerance, one or more shims and/or filler plates (e.g., filler material layers) can be positioned between the components to reduce or close the gap, reduce wear of the components, ensure structural capability to transfer loads, facilitate alignment of the components, etc.

### SUMMARY

An example apparatus includes a shim to be positioned between a first component and a second component. The first component is to be fastened to the second component. A guided fracture line is positioned in the shim, the guided fracture line defining a joint portion of the shim and a removable portion of the shim, the removable portion of the shim to extend outside of a peripheral edge of one of the first component or the second component, the guided fracture line to enable removal of the removable portion after the first component is fastened to the second component.

An example method includes providing a guided fracture line in a surface of a shim, the guided fracture line to define a joint portion of the shim and a removable portion of the shim, positioning the shim on a first component, positioning a second component on the joint portion of the shim, fastening the second component and the joint portion to the first component, and removing the removable portion from the shim.

An example shim disclosed herein is to be fastened between a first component and a second component. The shim includes an elongate recess in a surface of the shim, the elongate recess defining a first portion of the shim and a second portion of the shim, the elongate recess positioned outside of a contact area at which one of the first component or the second component is to contact the shim, the first portion including the contact area, the elongate recess to enable separation of the second portion from the first portion after the shim is fastened between the first component and the second component.

### BRIEF DESCRIPTION OF THE DRAWINGS

FIG. 1A illustrates an example shim constructed in accordance with teachings of this disclosure.

FIG. 1B illustrates a first alternative shape that may be used for the guided fracture line of FIG. 1A.

FIG. 1C illustrates a second alternative shape that may be used for the guided fracture line of FIG. 1A.

FIG. 1D illustrates a third alternative shape that may be used for the guided fracture line of FIG. 1A.

FIG. 2 illustrates an example stack assembly including first and second example shims constructed in accordance with teachings of this disclosure.

FIG. 3 is a detailed view of a portion of the first shim and the second shim of FIG. 2.

FIG. 4 illustrates the example stack assembly of FIG. 2 after removal of first and second removable portions of FIG. 2.

FIG. 5 illustrates a second example stack assembly constructed in accordance with teachings of this disclosure.

FIG. 6 is a detailed view of the first guided fracture line, the second guided fracture line, and the third guided fracture line of FIG. 5.

FIG. 7 is a detailed view of the first shim, the second shim, and the filler plate after removal of the first removable portion and the second removable portion of FIGS. 5 and/or 6.

FIG. 8 is a flowchart representative of an example method to produce examples disclosed herein.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

In some applications, it may be desirable to join together two or more components with an accuracy that is within a preselected threshold and/or tolerance. For instance, when joining two or more components in an assembly, the components may be required to be substantially aligned (e.g., such that corresponding edges of the components are substantially parallel to one another) and/or a gap between the components may be required to be less than a threshold (e.g., less than 0.1 inches, less than 0.005 inches, etc.). In some instances, when the gap exceeds the threshold, one or more shims and/or filler plates may be positioned between the components to fill the gap (e.g., to reduce the gap to within the threshold).

Shims are typically fabricated from stock material (e.g., sheet metal) by cutting or stamping the stock material to a desired shape and/or size. In some instances, the shim can be shaped and/or sized based on a peripheral edge of one or more components to be assembled and/or joined together. For instance, the shim may be sized such that, when the shim is coupled to the component(s) in an assembly, an edge of the shim extends outside of the peripheral edge of the component(s) by less than a threshold amount. In some cases, it may be desirable to reduce and/or limit an amount of shim material extending outside of the peripheral edge of the component(s) (e.g., in order to maintain joint strength of the assembly, reduce a footprint of the assembly, reduce likelihood of damage resulting from contact with the edges of the shim, etc.).

In some known assembly processes, components of an assembly (e.g., a stack assembly) are positioned in a desired arrangement (e.g., a stack) to facilitate alignment and/or positioning of fastener openings to be provided in the components. In some cases, after the fastener openings are provided (e.g., by drilling, etching, etc.), the stack is disassembled prior to fastening to allow for cleaning and/or deburring of the components. Such cleaning and/or deburring may be necessary to remove debris and/or sharp bits of material that may reduce strength and/or cause damage to one or more components of the stack. However, such disassembly, cleaning, and deburring processes may also add significant time and labor costs to the overall assembly process.

To address the drawbacks noted above, a one-up assembly (OUA) process has been developed in recent years for use in some industries (e.g., the aerospace industry). In a OUA process, the components to be joined together are positioned in a stack and clamped together prior to drilling and/or fastening of the components. For instance, the clamped stack can be drilled in a single motion to force out any debris and/or sharp material bits from the stack. As a result, the disassembly, cleaning, and deburring processes may be omitted (e.g., fasteners can be installed immediately after drilling of the stack) and, thus, the time and/or labor required for assembling the components may be reduced (e.g., compared to some known assembly processes).

In some cases, one or more shims and/or filler plates are positioned between two or more components of a stack assembly to fill and/or reduce gaps between the components. In some such cases, as a result of torque applied to the stack assembly during drilling, one or more of the shim(s) and/or filler layer(s) may shift and/or rotate from a desired position, and/or may otherwise become misaligned relative to other component(s) of the stack assembly. When movement and/or misalignment of the shim(s) occurs during drilling, disassembly and/or rework of the stack assembly is typically required (e.g., when the movement results in a misplaced and/or misoriented drill hole that disqualifies a corresponding joint from the OUA process). Such disassembly and/or rework may increase assembly times and/or part costs associated with the OUA process. In some cases, adhesives have been used between two or more components of the stack assembly to restrict movement of the shims during drilling. However, such adhesives may not be removable after drilling and, in some cases, may reduce joint strength and/or structural integrity of the final stack assembly (e.g., may reduce a maximum load that may be supported by the stack assembly).

Additionally, after joining of the components and shim(s) in a stack assembly, deburring tools and/or trimming tools may not be used to remove excess shim material due to the risk of such tools causing damage to one or more of the components. Therefore, shims are typically trimmed prior to installation. As a result of trimming, the shims may not have sufficient area to support the use of constraining device(s) (e.g., clamps, adhesives, etc.) to prevent and/or reduce shifting of the shims during drilling.

Disclosed herein are example shims and/or filler plates that address some the drawbacks mentioned above. An example shim disclosed herein is to be positioned and/or coupled (e.g., fastened) between a first component and a second component (e.g., in a stack-up assembly). The example shim includes an example guided fracture line (e.g., an elongate recess, a scored line) in a surface of the shim. The guided fracture line defines a joint portion of the shim and a removable portion of the shim, where the joint portion includes a contact area at which one of the first component or the second component is to contact the shim when the shim is fastened between the first and second components. In some examples, the shim can be fabricated (e.g., cut and/or stamped) from stock material (e.g., sheet metal), and the guided fracture line can be provided in the surface of the shim via at least one of a stamping process or an etching process.

In some examples, the shim can be utilized in an example stack assembly (e.g., a OUA stack) to reduce and/or eliminate the need for rework of the stack assembly after drilling and/or fastening. For example, during an assembly process (e.g., a OUA process), the shim is positioned between the first and second components, and one or more restraining devices (e.g., a clamp, an adhesive) can be used to removably and/or temporarily fix a position of the shim with respect to at least one of the first component or the second component. For example, the restraining device(s) are applied and/or coupled to the removable portion of the shim (e.g., outside of the joint portion and/or contact area of the shim), such that the restraining device(s) do not interfere with and/or otherwise prevent drilling of the stack assembly. Further, because the restraining devices are positioned outside of (e.g., at a distance away from) the joint portion of the shim, an opposing torque to be provided by the restraining device(s) can be increased (e.g., compared to when the restraining device(s) are positioned at the joint portion). As a result, when torque is applied to the stack assembly during drilling, the restraining devices on the removable portion of the shim can restrict and/or prevent movement (e.g., rotation and/or translation) of the shim.

After drilling and/or fastening of the stack assembly, the guided fracture line enables removal of the removable portion of the shim from the joint portion of the shim. After removal of the removable portion, the remaining shim (e.g., the joint portion) can extend outside of a peripheral edge of the first component and/or the second component by less than a threshold amount (e.g., 0.1 inches, 0.005 inches, etc.). As a result, utilizing example shims disclosed herein can reduce the need for disassembly and/or rework of the stack assembly and, thus, may reduce time and/or costs associated with a OUA process.

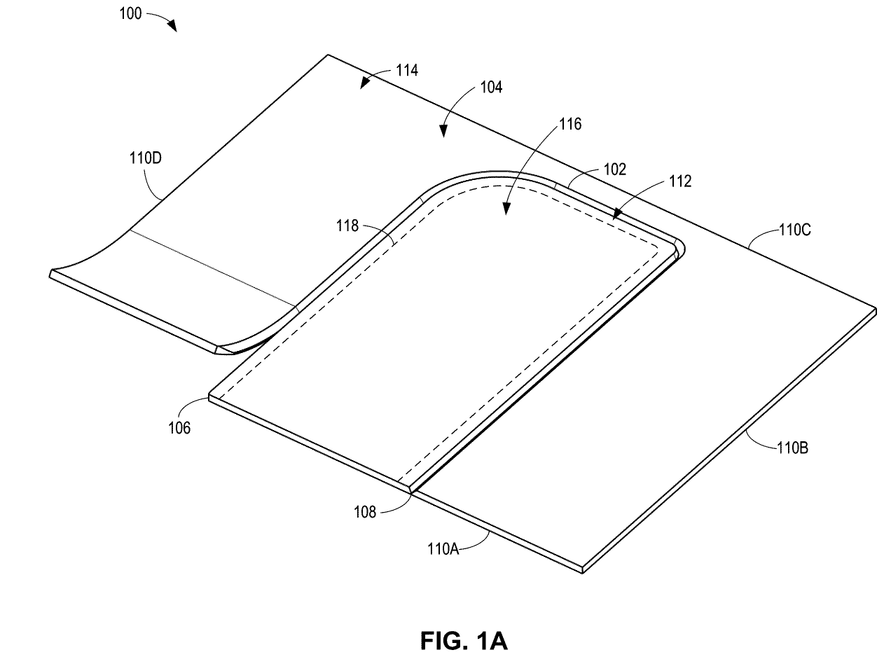

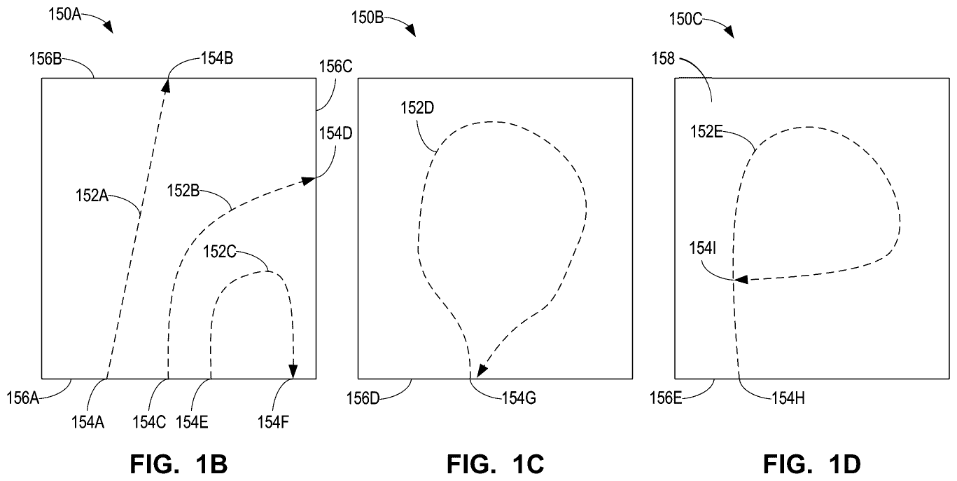

FIG. 1A illustrates an example shim (e.g., an oversized shim) 100 constructed in accordance with teachings of this disclosure. In the illustrated example of FIG. 1A, the shim 100 includes an example guided fracture line (e.g., a scored line, an elongate recess) 102 in a surface 104 of the shim 100. In this example, the guided fracture line 102 extends between a first example edge location 106 and a second example edge location 108 of the shim 100. While the first and second edge locations 106, 108 are along a same edge (e.g., a first edge 110A) of the shim 100 in this example, at least one of the first edge location 106 or the second edge location 110 can be on a different edge (e.g., a second edge 110B, a third edge 110C, or a fourth edge 110D) of the shim 100 in some examples. In some examples, the first edge location 106 and the second edge location 108 can correspond to a same location on one of the edges 110A, 110B, 110C, 110D (e.g., such that the guided fracture line 102 forms a closed looped). In some examples, the guided fracture line 102 does not terminate at an edge 110A, 110B, 110C, 110D of the shim 100 (e.g., the guided fracture line 102 intersects itself and/or terminates at a location on the surface 104 of the shim 100 to form a closed shape on the surface 104). Further, while the shim 100 in FIG. 1A is rectangular (e.g., has a rectangular cross-sectional shape), the shim 100 can have a different shape (e.g., circular, elliptical, hexagonal, etc.) in some examples.

Alternative example shapes that may be used for the guided fracture line 102 of FIG. 1A are shown in FIGS. 1B, 1C, and 1D. For example, FIG. 1B illustrates a second example shim 150A including a second example guided fracture line 152A, a third example guided fracture line 152B, and a fourth example guided fracture line 152C. In the illustrated example of FIG. 1B, the second guided fracture line 152A extends from a first location 154A along a first edge 156A of the second shim 150A to a second location 154B along a second edge 156B of the second shim 150A, where the first edge 156A is opposite the second edge 156B. Further, the third guided fracture line 152B extends from a third location 154C along the first edge 156A to a fourth location 154D along a third edge 156C of the second shim 150A, where the third edge 156C is adjacent to the first edge 156A. In this example, the fourth guided fracture line 152C extends from a fifth location 154E along the first edge 156A to a sixth location 154F along the first edge 156A.

FIG. 1C illustrates a third example shim 150B including a fifth example guided fracture line 152D. In the illustrated example of FIG. 1C, the fifth guided fracture line 152D extends from and to (e.g., begins and terminates at) a seventh location 154G along a fourth edge 156D of the third shim 150B. As a result, the fifth guided fracture line 152D forms a closed loop (e.g., a closed shape) in FIG. 1C.

FIG. 1D illustrates a fourth example shim 150C including a sixth example guided fracture line 152E. In the illustrated example of FIG. 1D, the sixth guided fracture line 152E extends from (e.g., begins at) an eighth location 154H along a fifth edge 156E of the fourth shim 150C, and terminates at a ninth location 154I of the fourth shim 150C. In this example, the ninth location 154I is on a surface 158 of the fourth shim 150C (e.g., not along any edge of the fourth shim 150C). For example, the ninth location 154I is along the sixth guided fracture line 152E in FIG. 1D (e.g., such that the sixth guided fracture line 152E forms a closed shape on the surface 158).

Returning to FIG. 1A, the guided fracture line 102 defines an example joint portion (e.g., a first portion, a joint area) 112 and an example removable portion (e.g., a second portion, a removable area) 114 of the shim 100. Further, the joint portion 112 includes an example contact area 116 (indicated by the dashed line in FIG. 1A) at which one or more components of an example stack assembly (e.g., a stack-up assembly, a OUA stack) are to be fastened and/or otherwise coupled to the surface 104 of the shim 100. In some examples, a shape of the contact area 116 substantially corresponds to a shape of a peripheral edge of the component(s) to be coupled to the surface 104. In the illustrated example of FIG. 1A, the guided fracture line 102 is positioned outside of and/or is spaced apart from the contact area 116 (e.g., does not intersect with the contact area 116), and a shape of the guided fracture line 102 substantially corresponds to at least a portion of the shape of the contact area 116. While the shim 100 includes one guided fracture line 102 in the example of FIG. 1A, the shim 100 may include multiple guided fracture lines 102 in some examples. For example, the multiple guided fracture lines 102 can define respective different joint portions 112 and/or contact areas 116 for respective different components to be coupled (e.g., fastened) to the surface 104 of the shim 100.

In the illustrated example of FIG. 1A, a distance (e.g., a spacing) between the guided fracture line 102 and a peripheral edge 118 of the contact area 116 is substantially the same (e.g., uniform) along a length (e.g., from the first edge location 106 to the second edge location 108) of the guided fracture line 102. Stated differently, a distance between the guided fracture line 102 and a closest point along the peripheral edge of the contact area 116 is substantially the same for any point along the guided fracture line 102. In some examples, the distance between the guided fracture line 102 and the peripheral edge of the contact area 116 may vary along the length of the guided fracture line 102 (e.g., the distance between the guided fracture line 102 and a closest point along the peripheral edge 118 of the contact area 116 may be different for different points along the guided fracture line 102).

In some examples, a position of the guided fracture line 102 on the surface 104 of the shim 100 is based on the shape of the peripheral edge of the contact area 116 and/or is based on a threshold distance (e.g., a tolerance) between the guided fracture line 102 and the contact area 116. For example, the guided fracture line 102 can be provided in the surface 104 (e.g., via an etching process, a stamping process, etc.) such that the distance between any point along the guided fracture line 102 and a corresponding closest point along the peripheral edge 118 of the contact area 116 satisfies (e.g., is less than or equal to) a preselected threshold. In some examples, the threshold distance is 0.1 inches. In some examples, the threshold distance can be different (e.g., greater than or less than 0.1 inches, 0.005 inches, etc.).

In the illustrated example of FIG. 1A, the guided fracture line 102 has a triangular cross-sectional shape (e.g., is substantially V-shaped). In some examples, a cross-sectional shape of the guided fracture line 102 may be different (e.g., rectangular, semicircular, etc.). In some examples, as a result of the etching and/or stamping processes used to provide the guided fracture line 102 in the surface 104 of the shim 100, a thickness of the shim 100 at the guided fracture line 102 is less than a thickness of the shim 100 at other location(s) (e.g., the contact area 116, the joint portion 112, and/or the removable portion 114) of the shim 100. In some such examples, the thickness of the shim 100 is less than half of the thickness of the other location(s) of the shim 100. In some examples, as a result of the reduced thickness at the guided fracture line 102, a fracture and/or tear in the shim 100 can propagate along the guided fracture line 102 to enable and/or facilitate removal (e.g., separation) of the removable portion 114 from the joint portion 112.

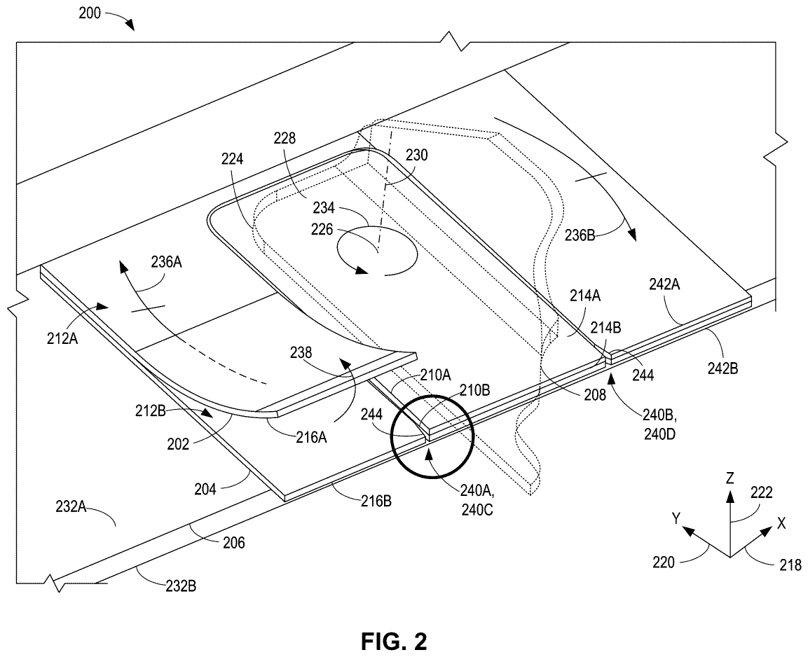

FIG. 2 illustrates an example stack assembly (e.g., a stack-up assembly, a OUA stack, a joint stack) 200 including first and second example shims 202, 204 constructed in accordance with teachings of this disclosure. In the illustrated example of FIG. 2, the first and second shims 202, 204 are to be coupled (e.g., fastened) between a first example component (e.g., a base, a base surface) 206 and a second example component 208 of the stack assembly 200. For example, the first shim 202 is to be coupled between the second shim 204 and the second component 208, and the second shim 204 is to be coupled between the first shim 202 and the first component 206. In some examples, at least one of the first component 206 or the second component 208 corresponds to a portion of a wing (e.g., a wing box) of an aircraft. In some examples, at least one of the first component 206 or the second component 208 can correspond to a different portion(s) and/or surface(s) of an aircraft (e.g., a fuselage of the aircraft, tail stabilizers of the aircraft, etc.). In some examples, the first component 206 and the second component 208 are not utilized in an aircraft. For example, the first component 206 and the second component 208 can correspond to any two components that are to be joined together in an assembly. In some examples, the first and second shims 202, 204 are positioned and/or fastened between the first and second components 206, 208 to eliminate and/or fill a gap therebetween (e.g., to reduce the gap to less than a threshold gap size).

In the illustrated example of FIG. 2, the first shim 202 includes a first example guided fracture line 210A positioned in a first example surface 212A of the first shim 202, and the second shim 204 includes a second example guided fracture line 210B positioned in a second example surface 212B of the second shim 204. In this example, the first and second guided fracture lines 210A, 210B define example joint portions 214A, 214 of the respective first and second shims 202, 204, and further define example removable portions 216A, 216B of the respective first and second shims 202, 204. In this example, the first and second guided fracture lines 210A, 210B are substantially aligned (e.g., have substantially the same shape on the respective surfaces 212A, 212B of the respective first and second shims 202, 204), such that the joint portions 214A, 214B have substantially the same size and shape.

Further, in this example, the first shim 202 has a first example length (e.g., in an example X direction 218), a first example width (e.g., in an example Y direction 220), and a first example thickness (e.g., in an example Z direction 222), and the second shim 204 has a second example length (e.g., in the X direction 218), a second example width (e.g., in the Y direction 220), and a second example thickness (e.g., in the Z direction 222). In this example, the first shim 202 and the second shim 204 have substantially the same dimensions (e.g., the first length of the first shim 202 is substantially equal to the second length of the second shim 204, the first width of the first shim 202 is substantially equal to the second width of the second shim 204, and the first thickness of the first shim 202 is substantially equal to the second thickness of the second shim 204). In some examples, at least one dimension (e.g., length, width, and/or thickness) may vary between the first and second shims 202, 204.

In the illustrated example of FIG. 2, to assemble and/or produce the stack assembly 200, the first and second shims 202, 204 are positioned on a first base surface 232A of the first component 206, and the second component 208 is positioned on the joint portion 214A of the first shim 202. In some examples, the second component 208 is positioned on the joint portion 214A such that a peripheral edge 224 of the second component 208 is spaced apart from (e.g., does not cross and/or overlap with) the guided fracture lines 210A, 210B, and the removable portions 216A, 216B of the first and second shims 202, 204 extend outside of the peripheral edge 224 of the second component 208. In some examples, the second component 208 is approximately centered on the joint portion 214A. In some examples, a spacing (e.g., a distance) between the peripheral edge 224 and a closest point along the guided fracture lines 210A, 210B is less than or equal to a threshold (e.g., 0.1 inches, 0.005 inches, etc.) for any point along the peripheral edge 224.

In some examples, to produce the stack assembly of FIG. 2 (e.g., via a OUA process), the second component 208 and the first and second shims 202, 204 are drilled at an example drill location 226 on a component surface 228 of the second component 208. For example, a drill and/or other tool(s) can be used to provide an opening (e.g., a fastener opening) at the drill location 226, where the opening extends along and/or is substantially aligned with an example drill axis 230 of the drill. In some examples, the opening extends from the component surface 228, through the first and second joint portions 214A, 214B of the first and second shims 202, 204, and to (and/or through at least a portion of) the first component 206. Further, a fastener can be positioned in the opening at the drill location 226 to fasten together the components (e.g., the first component 206, the first shim 202, the second shim 204, and the second component 208) of the stack assembly 200.

In some examples, the removable portions 216A, 216B enable the use of one or more example restraining devices to prevent and/or restrict movement (e.g., rotation and/or translation) of the shims 202, 204 during drilling of the stack assembly 200. For example, the restraining device(s) can be implemented on (e.g., positioned on, coupled to) the removable portion(s) 216A, 216B to restrain movement of the shims 202, 204 during drilling. In some examples, the restraining device(s) can include one or more clamps on the removable portions 216A, 216B of the shims 202, 204 (e.g., coupled between the first surface 212A of the first removable portion 216A and a second base surface 232B of the first component 206). Additionally or alternatively, the restraining device(s) can include adhesive(s) (e.g., adhesive layers, tape, etc.) positioned at an interface between the second removable portion 216B and the first base surface 232A, and/or extending from the first surface 212A and/or the second surface 212B to at least one of the first base surface 232A or the second base surface 232B. In some examples, the restraining device(s) can be used to oppose rotational forces (e.g., torque) applied to the stack assembly 200.

For example, during drilling of the stack assembly 200, the drill applies a first example torque (indicated by arrow 234) on the stack assembly 200. In the illustrated example of FIG. 2, the first torque 234 acts in first rotational direction about the drill axis 230 and/or along an example plane defined by the X and Y directions 218, 220. In some examples, as a result of the restraining device(s) fixing and/or restraining the position of the shims 202, 204 (e.g., with respect to the first component 206), the shims 202, 204 provide an opposing torque (indicated by arrows 236A, 236B) that can be substantially equal in magnitude and opposite in direction to the first torque 234. For example, the opposing torque 236A, 236B can act in a second rotational direction about the drill axis 230, where the second rotational direction is opposite the first rotational direction of the first torque 234. In some examples, by countering and/or opposing the first torque 234, the opposing torque 236A, 236B provided by the restraining device(s) can restrict movement (e.g., rotation and/or translation) of one or more components (e.g., the shims 202, 204 and/or the components 206, 208). As a result, the restraining device(s) can prevent and/or restrict misalignment between the components during drilling and, thus, can reduce the need for disassembly and/or rework of the stack assembly 200.

In some examples, a magnitude of the opposing torque 236A, 236B provided by the restraining device(s) is based on a clamping force of the restraining device(s) on the shims 202, 204, and is further based on distance(s) between the drill location 226 and the restraining device(s). For example, the opposing torque 236A, 236B may be increased by increasing the distance(s) between the restraining device(s) and the drill location 226 and, conversely, the opposing torque 236A, 236B may be reduced by reducing the distance(s) between the restraining device(s) and the drill location 226. Thus, by increasing an available area of the shims 202, 204 on which the restraining device(s) can be positioned, the removable portions 216A, 216B can increase a magnitude of the opposing torque 236A, 236B that may be provided by the restraining device(s).

For example, when the shims 202, 204 include the removable portions 216A, 216B, the restraining device(s) can be positioned at distance(s) further away from the drill location 226 (e.g., compared to when the shims 202, 204 do not include the removable portions 216A, 216B). In turn, the magnitude of the opposing torque 236A, 236B provided by the restraining device(s) may be greater when the restraining device(s) are coupled to the removable portion(s) 216A, 216B compared to when the restraining device(s) are coupled to different portion(s) of the shims 202, 204 (e.g., to the joint portion(s) 214A, 214B between the peripheral edge 224 of the second component 208 and the guided fracture line(s) 210A, 210B). Further, in some examples, an area of the joint portions 214A, 214B between the peripheral edge 224 of the second component 208 and the guided fracture lines 210A, 210B may be insufficient to enable positioning of the restraining device(s) on the joint portions 214A, 214B. In such examples, the removable portion(s) 216A, 216B can provide additional area to enable positioning of the restraining device(s) on the shims 202, 204.

In the illustrated example of FIG. 2, after drilling and/or fastening of the second component 208 to the first component 206, the removable portions 216A, 216B may be removed from the corresponding joint portions 214A, 214B of the shims 202, 204. For example, when an out-of-plane force 238 (e.g., a force acting at an angular offset with respect to an X-Y plane defined by the X direction 218 and the Y direction 220) is applied to the first removable portions 216A, the first shim 202 can fracture at the first guided fracture line 210A, and the fracture can propagate along the first guided fracture line 210A from a first edge location 240A to a second edge location 240B of the first shim 202 (e.g., where the first and second edge locations 240A, 240B are along a first edge 242A of the first shim 202). As a result, the removable portion 216A of the first shim 202 can be removed and/or separated from the joint portion 214A of the first shim 202, such that a remaining portion (e.g., the joint portion 214A) of the first shim 202 does not extend outside of the peripheral edge 224 of the second component 208 by more than a threshold (e.g., 0.1 inches, 0.005 inches, etc.). Similarly, an out-of-plane force may be applied to the second shim 204 to remove and/or separate the removable portion 216B of the second shim 204 from the joint portion 214B of the second shim 204 (e.g., by initiating and/or propagating a second fracture along the second guided fracture line 210B from a third edge location 240C to a fourth edge location 240D of the second shim 204, where the third and fourth edge locations 240C, 240D are along a second edge 242B of the second shim 204).

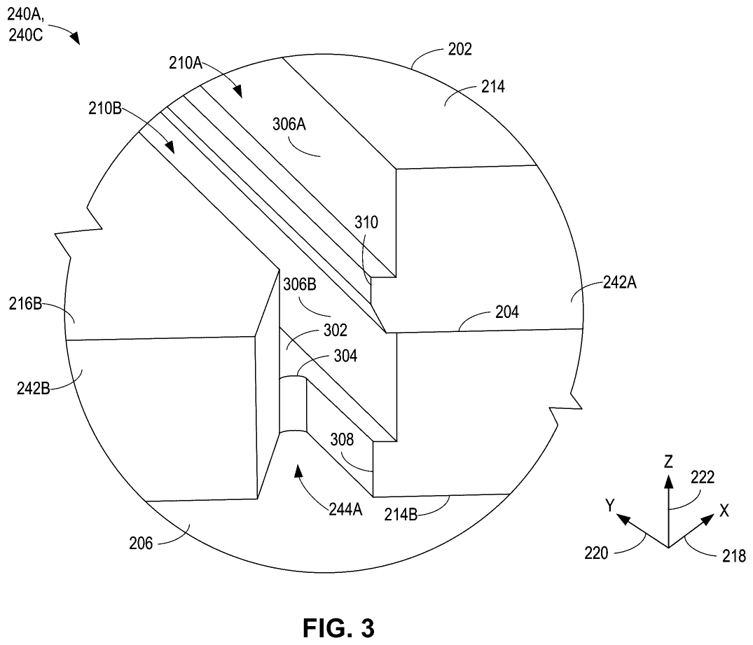

In some examples, the removable portions 216A, 216B may be removed simultaneously (e.g., at substantially the same time), or the removable portions 216A, 216B may be removed in a consecutive manner (e.g., the second removable portion 216B can be removed after the first removable portion 216A is removed). In some examples, as discussed further below in connection with FIG. 3, at least one of the first shim 202 or the second shim 204 can include one or more example notches 244 to facilitate initiation of fractures along the first guided fracture line 210A and/or the second guided fracture line 210B. For example, the notch(es) 244 can extend from the first edge 242A of the first shim 202 into the first guided fracture line 210A (e.g., at the first edge location 240A and/or the second edge location 240B of the first shim 202), and/or can extend from the second edge 242B of the second shim 204 into the second guided fracture line 210B (e.g., at the third edge location 240C and/or the fourth edge location 240D of the second shim 204).

FIG. 3 is a detailed view of a portion of the first shim 202 and the second shim 204 of FIG. 2. In particular, FIG. 3 shows a portion of the first shim 202 at the first edge location 240A and a portion of the second shim 204 at the third edge location 240C. While the first and third edge locations 240A, 240C are discussed in connection with FIG. 3, the description of the first and second shims 202, 204 at the first and third edge locations 240A, 240C can equally apply to the first and second shims 202, 204 at the second and fourth edge locations 240B, 240D of FIG. 2.

In the illustrated example of FIG. 3, the first shim 202 is shown after removal of the first removable portion 216A (FIG. 2) from the first joint portion 214A of the first shim 202, and the second shim 204 is shown prior to removal of the second removable portion 216B from the second joint portion 214B of the second shim 204. In some examples, a geometry of the first shim 202 prior to removal of the first removable portion 216A is substantially the same as a geometry of the second shim 204 as shown in FIG. 3, and the geometry of the second shim 204 after removal of the second removable portion 216B is substantially the same as the geometry of the first shim 202 as shown in FIG. 3.

In the illustrated example of FIG. 3, the second removable portion 216B and the second joint portion 214B are coupled together via an example material bridge 302 extending between the second removable portion 216B and the second joint portion 214B. Further, the second shim 202 includes a first example notch 244A extending from the second edge 242B of the second shim 204 to a location along the second guided fracture line 210B. In this example, the first notch 244A is substantially triangular with a rounded portion 304 in the material bridge 302, where a width of the first notch 244A decreases (e.g., in the Y direction 220) from the second edge 242B to the rounded portion 304. While the first notch 244A is substantially triangular in this example, a different shape (e.g., rectangular, semicircular, etc.) of the first notch 244A may be used instead. In some examples, the first notch 244A can be provided in the second shim 204 using at least one of a shear clipper (e.g., scissors), a band saw, or a different type of sawing tool. In some examples, a second notch (e.g., similar the first notch 244A) can be provided in the first shim 202, where the second notch can extend between the first edge 242A of the first shim 202 to a location along the first guided fracture line 210A of FIG. 2.

In some examples, the first notch 244A facilitates removal of the second removable portion 216B from the second joint portion 214B by providing a stress concentration location to initiate fracture of the second shim 204. For example, when an out-of-plane force (e.g., the out-of-plane force 238 of FIG. 2) is applied to the second removable portion 216B, the stress concentration at the first notch 244A can cause the second shim 204 to fracture at the first notch 244A and/or the second guided fracture line 210B (e.g., before fracture occurs at other locations of the second shim 204).

In the illustrated example of FIG. 3, prior to removal of the first and second removable portions 216A, 216B, the first and second joint portions 214A, 214A can have substantially the same edge profile (e.g., a first example edge profile) along respective fracture edge surfaces 306A, 306B of the first and second joint portions 214A, 214B. For example, the fracture edge surfaces 306A, 306B correspond to edges of the respective joint portions 214A, 214B that face the respective removable portions 216A, 216B and that define a portion of the respective guided fracture lines 210A, 210B. As shown in the example of FIG. 3, the second joint portion 214A of the second shim 204 has the first edge profile prior to removal of the second removable portion 216B. In this example, the first edge profile includes a substantially rectangular protrusion 308 extending from the second fracture edge surface 306B, where the substantially rectangular protrusion 308 is adjacent the second component 208.

In some examples, the edge profile of the first and second joint portions 214A, 214B may change (e.g., may be deformed relative to the first edge profile) after removal of the respective first and second removable portions 216A, 216B (e.g., as a result of shearing and/or tearing of the first and second shims 202, 204 along the respective guided fracture lines 210A, 210B). For example, in FIG. 3, the first joint portion 214A has a second example edge profile after removal of the first removable portion 216A of FIG. 2. In the illustrated example of FIG. 3, the second edge profile includes a chamfered protrusion 310 extending from the first fracture edge surface 306A and adjacent the second shim 204. In some examples, the second edge profile of the first joint portion 214A may be different compared to the edge profile shown in FIG. 3. For example, the second edge profile may not include the chamfered protrusion 310, and/or the second edge profile can include protrusion(s) that are rounded, curved, and/or otherwise non-rectangular.

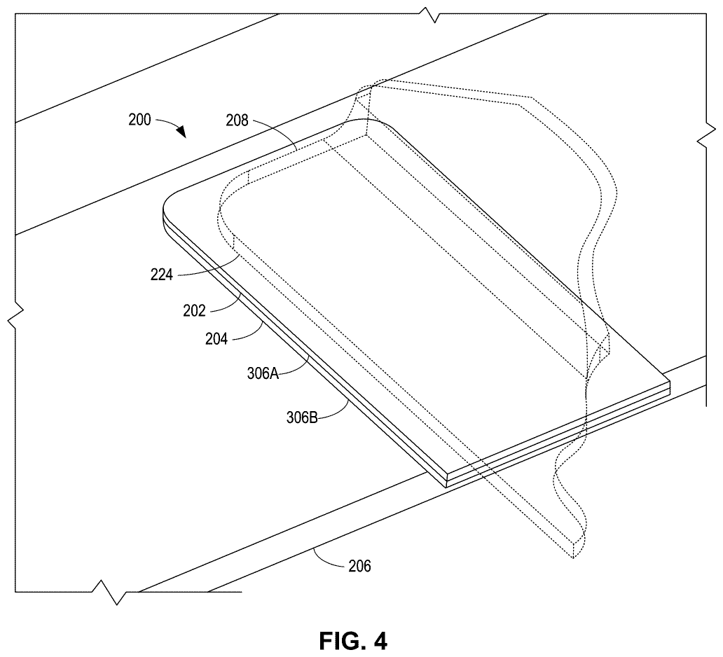

FIG. 4 illustrates the example stack assembly 200 of FIG. 2 after removal of the first and second removable portions 216A, 216B of FIG. 2. In the illustrated example of FIG. 4, the first and second shims 202, 204 extend outside of the peripheral edge 224 of the second component 208 by less than a threshold (e.g., less than 0.1 inches, etc.), and a gap between the first and second components 206, 208 may be less than a threshold gap (e.g., 0.005 inches, etc.). As a result of the relatively small amount of shim material extending outside of the peripheral edge 224 of the second component 208, the stack assembly 200 of FIG. 4 may produce a joint (e.g., a mechanical joint) that satisfies manufacturing tolerances for a given industry or application (e.g., an aerospace application). In some examples, after removal of the first and second removable portions 216A, 216B, one or more coatings (e.g., protective coating(s)) may be provided on at least a portion of the first fracture edge surface 306A and/or the second fracture edge surface 306B. In some such examples, the coating(s) may protect edge integrity of the first fracture edge surface 306A and/or the second fracture edge surface 306B, protect personnel that may interact or make contact with the first fracture edge surface 306A and/or the second fracture edge surface 306B, and/or may otherwise prevent and/or restrict damage caused by the shims 202, 204 (e.g., damage resulting from contact with sharp edges and/or protrusions along the fracture edge surface(s) 306A, 306B of the shims 202, 204).

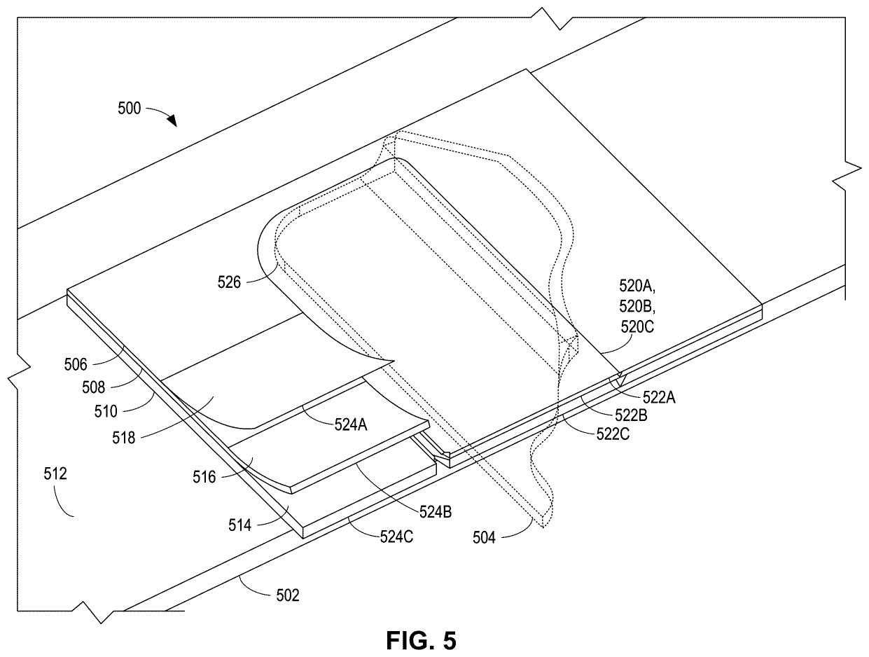

FIG. 5 illustrates a second example stack assembly (e.g., a second stack-up assembly, a second OUA stack, a second joint stack) 500 constructed in accordance with teachings of this disclosure. Similar to the stack assembly 200 of FIGS. 2 and/or 4, the second stack assembly 500 of FIG. 5 is used to couple together a first example component (e.g., a base) 502 and a second example component 504. However, while the stack assembly 200 of FIGS. 2 and/or 4 includes two shims (e.g., the first shim 202 and the second shim 204) positioned between the first and second components 206, 208 of FIGS. 2 and/or 4, the second stack assembly 500 of FIG. 5 includes three material layers (e.g., including an example laminate shim (e.g., a single laminate shim, a first shim) 506, example laminated shim stock (e.g., a second shim) 508, and an example filler plate (e.g., a filler layer, a solid filler plate) 510) positioned between the first and second components 502, 504 of FIG. 5.

For example, in FIG. 5, the filler plate 510 is positioned on a first surface 512 of the first component 502, the laminated shim stock 508 is positioned on a second surface 514 of the filler plate 510, the laminate shim 506 is positioned on a third surface 516 of the laminated shim stock 508, and the second component 504 is positioned on a fourth surface 518 of the laminate shim 506. While one laminate shim 506, one laminated shim stock 508, and one filler plate 510 are included in the second stack assembly 500 of FIG. 5, a different number of shim laminates (e.g., zero, two or more, etc.), a different number of laminated shim stocks (e.g., zero, two or more, etc.), and/or a different number of filler plates (e.g., zero, two or more, etc.) may be used instead. For example, the number and/or arrangement of shim laminate(s), laminated shim stock(s), and/or filler plate(s) may be selected based on a size of a gap between the first and second components 502, 504 to be filled using the shim laminate(s), laminated shim stock(s), and/or filler plate(s).

In this example, a first thickness of the laminate shim 506 is less than a second thickness of the laminated shim stock 508, and the second thickness of the laminated shim stock 508 is less than a third thickness of the filler plate 510. In some examples, the first thickness of the laminate shim 506 and/or the second thickness of the laminated shim stock 508 can be 0.063 inches or less (e.g., at least 0.003 inches and up to 0.063 inches), and the third thickness of the filler plate 510 is 0.2 inches or less (e.g., at least 0.03 inches and up to 0.2 inches). In some examples, the laminate shim 506, the laminated shim stock 508, and/or the filler plate 510 can include a metallic material (e.g., steel, aluminum, etc.) and/or a composite material. In some examples, the same materials can be used for the laminate shim 506, the laminated shim stock 508, and the filler plate 510. In some examples, the materials can be different between two or more of the laminate shim 506, the laminated shim stock 508, and the filler plate 510.

In the illustrated example of FIG. 5, the laminate shim 506, the laminated shim stock 508, and the filler plate 510 include respective example guided fracture lines (e.g., elongate recesses, score lines) 520A, 520B, 520C in the respective surfaces 514, 516, 518. In this example, the guided fracture lines 520A, 520B, 520C define respective example joint portions 522A, 522B, 522C and example removable portions 524A, 524B, 524C of the respective laminate shim 506, the laminated shim stock 508, and the filler plate 510. Similar to the guided fracture lines 210A, 210B of the stack assembly 200 of FIG. 2, the guided fracture lines 520A, 520B, 520C of FIG. 5 enable removal and/or separation of the removable portions 524A, 524B, 524C from the respective joint portions 522A, 522B, 522C. In some examples, after removal of the removable portions 524A, 524B, 524C, the laminate shim 506, the laminated shim stock 508, and/or the filler plate 510 can extend outside a peripheral edge 526 of the second component 504 by less than a threshold (e.g., 0.1 inches or less).

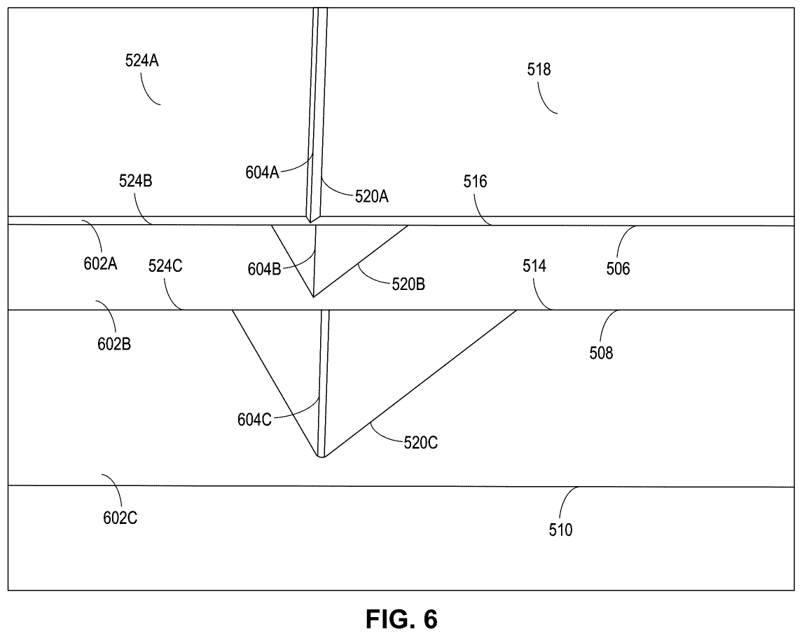

FIG. 6 is a detailed view of the first guided fracture line 520A, the second guided fracture line 520B, and the third guided fracture line 520C of FIG. 5. In the illustrated example of FIG. 6, the guided fracture lines 520A, 520B, 520C are shown proximate first, second, and third edges 602A, 602B, 602C of the laminate shim 506, the laminated shim stock 508, and the filler plate 510, respectively. In this example, the guided fracture lines 520A, 520B, 520C have a triangular cross-sectional shape. In some examples, widths of the guided fracture lines 520A, 520B, 520C decrease from the respective surfaces 518, 516, 514 to respective inner edges 604A, 604B, 604C of the laminate shim 506, the laminated shim stock 508, and the filler plate 510. In this example, the inner edges 604A, 604B, 604C correspond to locations along the respective guided fracture lines 520A, 520B, 520C at which the thicknesses of the respective laminate shim 506, the laminated shim stock 508, and/or the filler plate 510 are the smallest (e.g., the thicknesses along the inner edges 604A, 604B, 604C are less than the thicknesses at other locations of the respective laminate shim 506, the laminated shim stock 508, and/or the filler plate 510). In some examples, as a result of the reduced thicknesses along the inner edges 604A, 604B, 604C, the laminate shim 506, the laminated shim stock 508, and the filler plate 510 are more likely to fracture along the inner edges 604A, 604B, 604C (e.g., relative to other locations of the laminate shim 506, the laminated shim stock 508, and/or the filler plate 510).

In this example, the inner edges 604A, 604B, 604C are substantially aligned. As a result, the laminate shim 506, the laminated shim stock 508, and the filler plate 510 can have substantially the same size and/or shape after removal of the removable portions 524A, 524B, 524C. In some examples, at least one of the laminate shim 506, the laminated shim stock 508, or the filler plate 510 can include one or more notches extending from the respective edges 602A, 602B, 602C to the inner edges 604A, 604B, 604C to facilitate initiation of fractures along the inner edges 604A, 604B, 604C and, thus, along the guided fracture lines 520A, 520B, 520C.

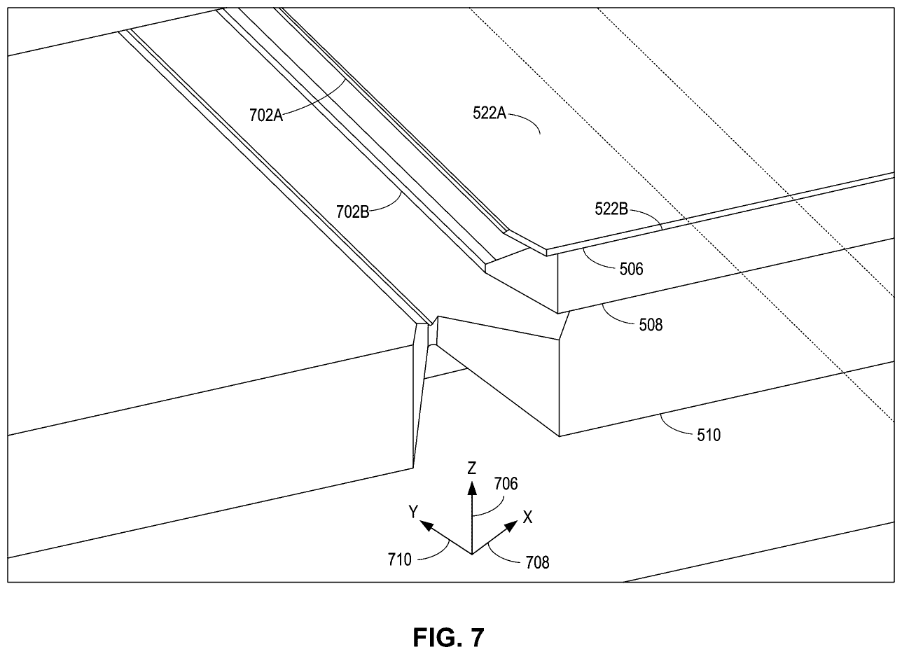

FIG. 7 is a detailed view of the laminate shim 506, the laminated shim stock 508, and the filler plate 510 after removal of the first removable portion 524A and the second removable portion 524B of FIGS. 5 and/or 6. In the illustrated example of FIG. 7, the laminate shim 506 and the laminated shim stock 508 include example fracture edges 702A, 702B at which the first and second joint portions 522A, 522B were coupled to the respective removable portions 524A, 524B (e.g., prior to removal of the removable portions 524A, 524B). In some examples, as a result of the removal of the removable portions 524A, 524B, the fracture edges 702A, 702B may be angled upward (e.g., angled in an example Z direction 706 of FIG. 7, angled with respect to a plane defined by an example X direction 708 and an example Y direction 710 of FIG. 7, etc.). In some examples, a coating (e.g., a protective coating) may be applied to at least one of the first fracture edge 702A or the second fracture edge 702B. In some examples, the coating may be used to prevent and/or reduce damage resulting from contact with the first fracture edge 702A and/or the second fracture edge 702B (e.g., damage and/or injury resulting from contact between personnel and the fracture edge(s) 702A, 702B), protect integrity of the fracture edge(s) 702A, 702B, etc.

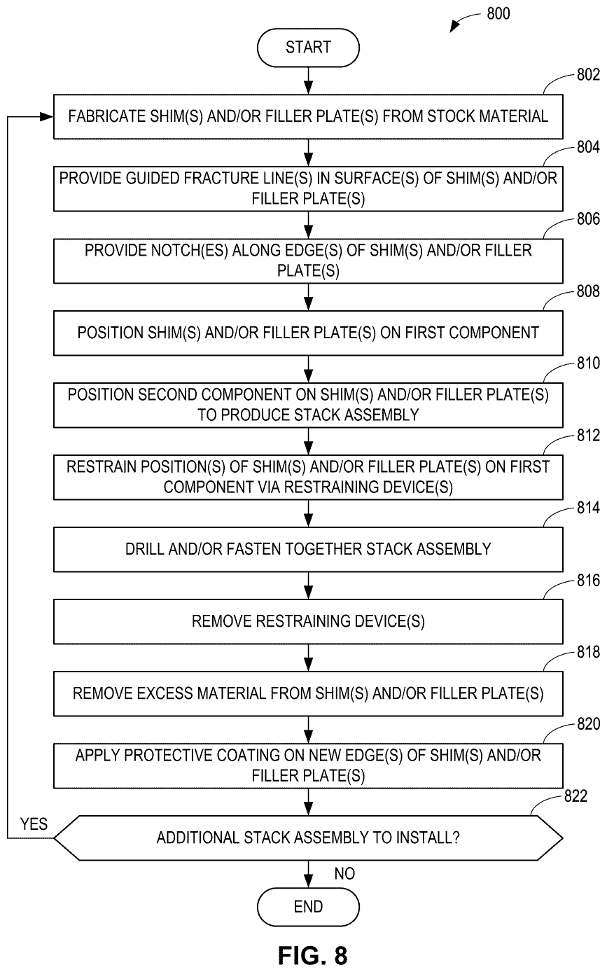

FIG. 8 is a flowchart representative of an example method 800 to produce examples disclosed herein. For example, the method 800 of FIG. 8 may be used to produce the example stack assembly 200 of FIGS. 2 and/or 4 and/or the second example stack assembly 500 of FIG. 5. Although the example method 800 is described with reference to the flowchart illustrated in FIG. 8, many other methods may alternatively be used. For example, the order of execution of the blocks may be changed, and/or some of the blocks described may be combined, divided, re-arranged, omitted, eliminated, and/or implemented in any other way. Further, in some examples, additional processing operations can be performed before, between, and/or after any of the blocks represented in the illustrated example.

At block 802, the example method 800 includes fabricating one or more shims and/or one or more filler plates from example stock material (e.g., metallic sheets, etc.). For example, the shims 202, 204 of FIGS. 2 and/or 4, the laminate shim 506 of FIG. 5, the laminated shim stock 508 of FIG. 5, and/or the filler plate 510 of FIG. 5 via at least one of cutting and/or stamping the stock material to a desired size and/or shape of the shim(s) 202, 204, 506, 508 and/or the filler plate 510. In some examples, the stock material can include one or more sheets of metallic and/or composite material, where the sheet(s) can have the same or different thicknesses (e.g., 0.2 inches or less, 0.063 inches or less, etc.).

At block 804, the example method 800 includes providing one or more example guided fracture lines in surface(s) of the shim(s) and/or the filler plate(s). For example, the first guided fracture line 210A of FIG. 2, the second guided fracture line 210B of FIG. 2, the first guided fracture line 520A of FIG. 5, the second guided fracture line 520B of FIG. 5, and/or the third guided fracture line 520C of FIG. 5 can be provided in the respective shim(s) 202, 204, 506, 508 and/or the filler plate 510 by stamping (e.g., via a stamping tool) and/or etching (e.g., via an etching tool) the surface(s) 212A, 212B, 518, 516, 514 of the respective shim(s) 202, 204, 506, 508 and/or the filler plate 510. In some examples, as a result of the etching and/or stamping, the guided fracture line(s) 210A, 210B, 520A, 520B, 520C define the joint portion(s) 214A, 214B, 522A, 522B, 522C and the removable portion(s) 216A, 216B, 524A, 524B, 524C of the respective shim(s) 202, 204, 506, 508 and/or the filler plate 510.

At block 806, the example method 800 includes providing one or more example notches along edge(s) of the shim(s) and/or the filler plate(s). For example, the notch(es) (e.g., the notches 244 of FIG. 2) can be provided using a shear clipper (e.g., scissors), a band saw, and/or other sawing tool(s). In some examples, the notch(es) can extend from the edge(s) 242A, 242B, 602A, 602B, 602C into and/or toward the guided fracture line(s) 210A, 210B, 520A, 520B, 520C of the respective shim(s) 202, 204, 506, 508 and/or the filler plate 510.

At block 808, the example method 800 includes positioning the shim(s) and/or the filler plate(s) on a first example component. For example, the first and second shims 202, 204 of FIG. 2 can be positioned on the first base surface 232A of the first component 206 of FIG. 2. In some examples, the laminate shim 506, the laminated shim stock 508, and the filler plate 510 can be positioned on the first surface 512 of the first component 502 of FIG. 5.

At block 810, the example method 800 includes positioning a second example component on the shim(s) and/or the filler plate(s) to produce an example stack assembly. For example, the second component 208 of FIG. 2 can be positioned on the joint portions 214A, 214B, of the first and second shims 202, 204 of FIG. 2 to produce the stack assembly 200 of FIG. 2. In some examples, the second component 504 of FIG. 5 can be positioned on the joint portions 522A, 522B, 522C of the first and second laminate shim 506, the laminated shim stock 508, and the filler plate 510 of FIG. 5 to produce the second stack assembly 500 of FIG. 5.

At block 812, the example method 800 includes restraining position(s) of the shim(s) and/or the filler plate(s) on the first component via one or more example restraining devices. For example, the restraining devices can include one or more clamps and/or adhesives positioned on and/or coupled (e.g., removably coupled) to the removable portion(s) 216A, 216B, 524A, 524B, 524C of the respective shim(s) 202, 204, 506, 508 and/or the filler plate 510. Additionally or alternatively, one or more of the restraining devices can be positioned on and/or coupled to the second component(s) 208, 504 to restrain position(s) and/or restrict movement of the second component(s) 208, 504 on the respective joint portion(s) 214A, 214B, 522A, 522B, 522C.

At block 814, the example method 800 includes drilling and/or fastening together the stack assembly. For example, a drilling tool can be used to drill (e.g., in the Z direction 222 and/or opposite to the Z direction 222 of FIG. 2) through the second component(s) 208, 504, the shim(s) 202, 204, 506, 508, and/or the filler plate 510 to fasten the second component(s) 208, 504 to the respective first component(s) 206, 502.

At block 816, the example method 800 includes removing the restraining device(s). For example, the restraining device(s) (e.g., the clamp(s) and/or the adhesives) can be removed from the removable portion(s) 216A, 216B, 524A, 524B, 524C to enable movement of the removable portion(s) 216A, 216B, 524A, 524B, 524C relative to the first component(s) 206, 502.

At block 818, the example method 800 includes moving excess material from the shim(s) and/or the filler plate(s). For example, the guided fracture line(s) 210A, 210B, 520A, 520B, 520C enable removal and/or separation of the removable portion(s) 216A, 216B, 524A, 524B, 524C from the respective joint portion(s) 214A, 214B, 522A, 522B, 522C.

At block 820, the example method 800 includes applying a protective coating on new edge(s) of the shim(s) and/or the filler plate(s). For example, the protecting coating can be applied to the fracture edge surfaces 306A, 306B of the first and second shims 202, 204 of FIGS. 2 and/or 4, and/or to the fracture edges 702A, 702B of the laminate shim 506 and the laminated shim stock 508 of FIG. 7.

At block 822, the example method 800 includes determining whether there is at least one additional stack assembly to install. In response to determining that there is at least one additional stack assembly to install (e.g., block 822 returns a result of YES), control returns to block 802. Alternatively, in response to determining that there are no additional stack assemblies to install (e.g., block 822 returns a result of NO), control ends.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C.

As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B.

As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time +1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

From the foregoing, it will be appreciated that example shims and associated methods have been disclosed to improve efficiency of a OUA process. An example shim (and/or filler plate) disclosed herein includes a guided fracture line to define a joint portion and a removable portion of the shim. The shim can be positioned between a first component and a second component of an example stack assembly, where the removable portion of the shim can be restrained (e.g., via clamps and/or adhesives) to restrict and/or prevent movement of the shim during drilling of the stack assembly. Because restraining devices can be positioned on the removable portion outside of (e.g., at a distance away from) the joint portion of the shim, an opposing torque to be provided by the restraining devices can be increased (e.g., compared to when the restraining devices are positioned at the joint portion). Additionally, the guided fracture line enables removal of the removable portion of the shim from the joint portion of the shim after fastening of the stack assembly. As a result, the remaining shim (e.g., the joint portion) extends outside of a peripheral edge of the first component and/or the second component by less than a threshold amount, thus reducing the need for disassembly and/or rework of the stack assembly. Disclosed systems, apparatus, articles of manufacture, and methods are accordingly directed to one or more improvement(s) in the operation of a machine or other electronic and/or mechanical device.

Example shims having guided fracture lines are disclosed herein. Further examples and combinations thereof include the following:
Example 1 includes an apparatus comprising a shim to be positioned between a first component and a second component, the first component to be fastened to the second component, and a guided fracture line positioned in the shim, the guided fracture line defining a joint portion of the shim and a removable portion of the shim, the removable portion of the shim to extend outside of a peripheral edge of one of the first component or the second component, the guided fracture line to enable removal of the removable portion after the first component is fastened to the second component.
Example 2 includes the apparatus of example 1, wherein a spacing between the peripheral edge and the guided fracture line is to be approximately 0.1 inches or less.
Example 3 includes the apparatus of example 1, wherein the shim is a first shim, the guided fracture line is a first guided fracture line, further including at least one of a second shim or a filler plate to be positioned between the first shim and the one of the first component or the second component, the at least one of the second shim or the filler plate including a second guided fracture line substantially aligned with the first guided fracture line.
Example 4 includes the apparatus of example 3, wherein a first thickness of the first shim is 0.063 inches or less, and a second thickness of the filler plate is 0.2 inches or less.
Example 5 includes the apparatus of example 1, wherein the shim includes a notch extending from an edge of the shim into or toward the guided fracture line.
Example 6 includes the apparatus of example 1, wherein at least one of the first component or the second component corresponds to a component of an aircraft.
Example 7 includes the apparatus of example 1, wherein the removable portion is removably coupled to the second component via at least one of a clamp or an adhesive.
Example 8 includes the apparatus of example 1, wherein the guided fracture line has at least one of a rectangular cross-sectional shape or a triangular cross-sectional shape.
Example 9 includes a method comprising providing a guided fracture line in a surface of a shim, the guided fracture line to define a joint portion of the shim and a removable portion of the shim, positioning the shim on a first component, positioning a second component on the joint portion of the shim, fastening the second component and the joint portion to the first component, and removing the removable portion from the shim.
Example 10 includes the method of example 9, further including at least one of stamping or etching the guided fracture line in the surface of the shim.
Example 11 includes the method of example 9, further including, prior to fastening the second component and the joint portion to the first component, removably coupling the removable portion to the first component via at least one of a clamp or an adhesive.
Example 12 includes the method of example 9, further including providing a notch in the shim, the notch extending from an edge of the shim into or toward the guided fracture line.
Example 13 includes the method of example 9, wherein the shim is a first shim, further including positioning at least one of a second shim or a filler plate between the first shim and at least one of the first component or the second component.
Example 14 includes the method of example 13, wherein the guided fracture line is a first guided fracture line, further including providing a second guided fracture line in the at least one of the second shim or the filler plate, the second guided fracture line substantially aligned with the first guided fracture line.
Example 15 includes the method of example 9, further including, after removing the removable portion, applying a protective coating on an edge of the shim.
Example 16 includes a shim to be fastened between a first component and a second component, the shim including an elongate recess in a surface of the shim, the elongate recess defining a first portion of the shim and a second portion of the shim, the elongate recess positioned outside of a contact area at which one of the first component or the second component is to contact the shim, the first portion including the contact area, the elongate recess to enable separation of the second portion from the first portion after the shim is fastened between the first component and the second component.
Example 17 includes the shim of example 16, wherein the shim has a first thickness at the first portion and the second portion, and the shim has a second thickness at the elongate recess, the second thickness less than the first thickness.
Example 18 includes the shim of example 16, wherein the elongate recess extends from a first edge location of the shim to a second edge location of the shim, further including a notch at one of the first edge location or the second edge location.
Example 19 includes the shim of example 16, wherein the elongate recess has at least one of a rectangular cross-sectional shape or a triangular cross-sectional shape.
Example 20 includes the shim of example 16, wherein a spacing between the elongate recess and the contact area is to be approximately 0.1 inches or less along a length of the elongate recess.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. An apparatus comprising:
a shim including a joint portion of uniform thickness to be positioned between a first component and a second component, the first component to be fastened to the second component; and
a guided fracture line including at least one curved portion positioned in the shim, the guided fracture line defining the joint portion of the shim and a removable portion of the shim, the removable portion of the shim to extend outside of a peripheral edge of one of the first component or the second component, the guided fracture line to enable removal of the removable portion after the first component is fastened to the second component.

2. The apparatus of claim 1, wherein a spacing between the peripheral edge and the guided fracture line is to be approximately 0.1 inches or less.

3. The apparatus of claim 1, wherein the shim is a first shim, the guided fracture line is a first guided fracture line, further including at least one of a second shim or a filler plate to be positioned between the first shim and the one of the first component or the second component, the at least one of the second shim or the filler plate including a second guided fracture line substantially aligned with the first guided fracture line.

4. The apparatus of claim 3, wherein a first thickness of the first shim is 0.063 inches or less, and a second thickness of the filler plate is 0.2 inches or less.

5. The apparatus of claim 1, wherein the shim includes a notch extending from an edge of the shim into or toward the guided fracture line.

6. The apparatus of claim 1, wherein at least one of the first component or the second component corresponds to a component of an aircraft.

7. The apparatus of claim 1, wherein the removable portion is removably coupled to the second component via at least one of a clamp or an adhesive.

8. The apparatus of claim 1, wherein the guided fracture line has at least one of a rectangular cross-sectional shape or a triangular cross-sectional shape.

9. A method comprising:
providing a guided fracture line in a surface of a shim, the guided fracture line to define a joint portion of the shim having uniform thickness and a removable portion of the shim having the same uniform thickness;
positioning the shim on a first component;
positioning a second component on the joint portion of the shim;
fastening the second component and the joint portion to the first component; and
removing the removable portion from the shim.

10. The method of claim 9, further including at least one of stamping or etching the guided fracture line in the surface of the shim.

11. The method of claim 9, further including, prior to fastening the second component and the joint portion to the first component, removably coupling the removable portion to the first component via at least one of a clamp or an adhesive.

12. The method of claim 9, further including providing a notch in the shim, the notch extending from an edge of the shim into or toward the guided fracture line.

13. The method of claim 9, wherein the shim is a first shim, further including positioning at least one of a second shim or a filler plate between the first shim and at least one of the first component or the second component.

14. The method of claim 13, wherein the guided fracture line is a first guided fracture line, further including providing a second guided fracture line in the at least one of the second shim or the filler plate, the second guided fracture line substantially aligned with the first guided fracture line.

15. The method of claim 9, further including, after removing the removable portion, applying a protective coating on an edge of the shim.

16. A shim including a first portion of uniform thickness to be fastened between a first component and a second component, the shim including an elongate recess in a surface of the shim, the elongate recess defining the first portion of the shim and a second portion of the shim, the second portion having the same uniform thickness as the first portion, the elongate recess positioned outside of a contact area at which one of the first component or the second component is to contact the shim, the first portion including the contact area, the elongate recess to enable separation of the second portion from the first portion after the shim is fastened between the first component and the second component.

17. The shim of claim 16, wherein the shim has a first thickness at the first portion and the second portion, and the shim has a second thickness at the elongate recess, the second thickness less than the first thickness.

18. The shim of claim 16, wherein the elongate recess extends from a first edge location of the shim to a second edge location of the shim, further including a notch at one of the first edge location or the second edge location.

19. The shim of claim 16, wherein the elongate recess has at least one of a rectangular cross-sectional shape or a triangular cross-sectional shape.

20. The shim of claim 16, wherein a spacing between the elongate recess and the contact area is to be approximately 0.1 inches or less along a length of the elongate recess.
